(19) United States
(12) Patent Application Publication
(10) Pub. No.: US 2017/0025804 A1
(43) Pub. Date: Jan. 26, 2017

(54) EARTHING CONDUCTOR ELEMENT FOR SWITCHBOARD TERMINAL BLOCKS AND ASSOCIATED TERMINAL BLOCK FOR EARTHING EARTH WIRES

(71) Applicant: Morsettitalia S.p.A., Milano (IT)

(72) Inventor: Giordano Pizzi, Milano (IT)

(21) Appl. No.: 15/015,953

(22) Filed: Feb. 4, 2016

(30) Foreign Application Priority Data
Feb. 5, 2015 (IT) MI2015A000152

(51) Int. Cl. H01R 25/14; H01R 9/24; H01R 13/627

(52) U.S. Cl. CPC H01R 25/142; H01R 13/627; H01R 9/2483

(57) ABSTRACT

An earth-conducting element includes a conductor lamina designed to electrically connect together two wires and a substantially vertical shaped body extending in the longitudinal direction. The substantially vertical shaped body including a bottom body section having a bottom free edge, a first end, a second end, and a flat-lamina spring. The bottom free edge extends in the longitudinal direction for resting in the vertical direction on a DIN-standard rail. The first end includes a tooth to engage with one of the two folded flanges of the DIN standard rail B. The second end is opposite to the first end and is designed to form a means for engaging and retaining the flat-lamina spring. The flat-lamina spring includes a head and two flat-pins legs for engagement with the other folded flange of the rail.

### RELATED APPLICATIONS

This application claims priority under 35 U.S.C. §119 to Italian Patent Application No. MI2015A000152 filed Feb. 5, 2015, the entire content of which is hereby incorporated by reference herein.

### FIELD

The present subject matter relates to a switchboard terminal block for connecting ground electric wires to a corresponding common reference point.

### BACKGROUND

It is known, in the technical sector relating to the production of switchboards for the wiring of electrical installations, to use terminal blocks designed to be mounted on associated supports and to provide on the front side access to the retaining means—normally of the screw or spring type—for electric wires to be connected in order to ensure continuity of the various sections of the electric circuit. The continuity achieved by inserting inside a special seat, accessible from the front, movable contact elements such as protection fuses, electric circuit breakers or jumpers for connecting together two adjacent terminal blocks. It is also known that at least one of the terminal blocks of the switchboard must be used for the connection to ground of the respective wires of the circuit.

According to the prior art such a ground connection is obtained by means of terminal blocks, a conductor lamina of which is electrically connected to the DIN rail supporting the terminal block assembly.

DE 44 09 206 C1 describes a grounding conductor element.

### SUMMARY

The technical problem which is posed, therefore, is that of providing a terminal block, in particular of the type used in switchboards for wired circuits, which allows the user to perform the ground connection of the associated ground wires, by means of DIN support rails, in an easy, reversible and safe way, while maintaining the necessary conductive capacity for the protection and safety of the system installed. In connection with this problem, this terminal block should maintain the standard dimensions imposed by the connections and should be easy and inexpensive to produce and assemble.

These results are obtained according to the present subject matter by a grounding conductor element for switchboard terminal and by a terminal block for grounding electric wires.

### DESCRIPTION OF THE DRAWINGS

Further details may be obtained from the following description of a non-limiting example of embodiment of the present subject matter, provided with reference to the accompanying drawings, in which:

FIG. 1 shows an exploded perspective view of a grounding conductor element for switchboard terminal blocks according to the present subject matter;

FIG. 2 shows a detailed side view of the form of one of the two longitudinal ends of the conductor element according to FIG. 1;

FIG. 3 shows a detailed side view of the conductor element assembled together with a flat-lamina spring for engagement on a DIN rail;

FIG. 4 shows a perspective view of the conductor element mounted on a switchboard DIN rail;

FIG. 5 shows a side view of an open terminal block with grounding conductor element according to the present subject matter;

FIG. 6 shows a perspective view of a second preferred embodiment of the grounding conductor element according to the present subject matter; and

FIG. 7 shows a view of a two-tier terminal block open laterally with a grounding conductor element according to FIG. 6.

### DETAILED DESCRIPTION

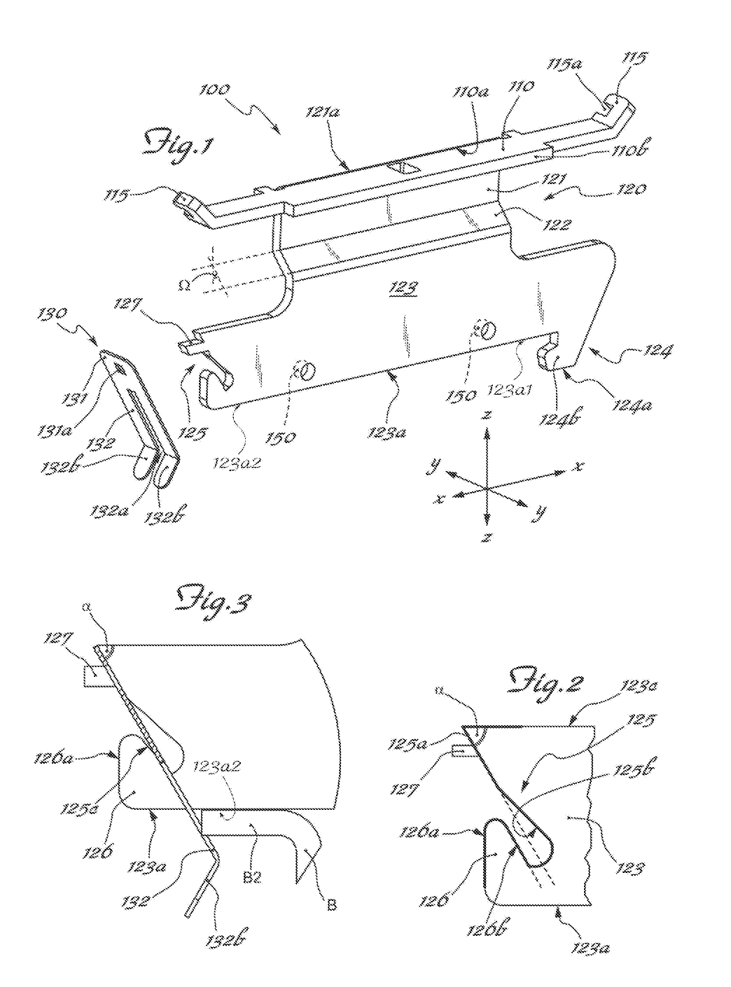

As shown in FIG. 1 the conductor element includes a conductor body 100. The conductor body 100 includes a conductor lamina 110 and a substantially vertical shaped body 120. The conductor lamina 110 extends in the longitudinal direction X-X and is designed to electrically connect together in the longitudinal direction two wires 2 inserted on opposite sides of a terminal block 10.

The substantially vertical shaped body 120 extends in the longitudinal direction X-X. The substantially vertical shaped body 120 includes a first substantially vertical body section 121, a second section 122, and a substantially vertical third section 123. The first substantially vertical body section 121 includes an edge 121a-situated at the top according to the layout shown in the figure—for connecting in the transverse direction Y-Y to a longitudinal edge 110a of the lamina 110 with which it forms one piece. The second section 122 is inclined with respect to the vertical section 121 from the top downwards and from the edge 110a towards the free edge 110b of the lamina 110 at a suitable angle Q. The substantially vertical third section 123 has its top edge connected to the second inclined section and includes a free bottom edge 123a for resting on the top surface of both folded flanges B1,B2 of a rail B, by means of a first edge section 123a1 and a second edge section 123a2. First edge section 123a1 and second edge section 123a2 are situated opposite each other in the longitudinal direction X-X and aligned in the vertical direction Z-Z for conductively resting on a respective one B1;B2 of the flanges of the rail B. The third section can be arranged in a vertical plane within the width of the lamina 110 in the transverse direction Y-Y, and can be substantially parallel to the free edge 110b of the lamina 110, opposite to that 110a connected to the first section 121.

The third section 123 of the conductor element includes a first end 124 and a second end 125. The first end 124 is proximal to and integral with the first section 123a1 of the edge 123a and the bottom edge 124a of which has a first tooth 124b projecting beyond the resting edge 123a in the vertical direction Z-Z and extending in the longitudinal direction X-X and inwards and designed to engage with one B1 of the two folded flanges B1,B2 of a DIN-standard rail B.

The second end 125 is opposite to the first end 124 proximal to and integral with the second edge section 123a2. The second end 125 has, from the top downwards (with reference to FIG. 2) a first edge 125a, a second edge 125b, and a second tooth 126. The first edge 125a is inclined at a suitable angle α with respect to a horizontal longitudinal edge 123a parallel to the bottom free resting edge 123a of the third body section 120. The first edge 125a can have a pin 127, which extends outwards in the longitudinal direction X-X. The second edge 125b is inclined inwards at a suitable obtuse angle with respect to the first edge 125a. The second tooth 126 includes an outer edge 126a, which is substantially parallel to the vertical direction Z-Z and the inner edge 126b, which is on the outside of and parallel with the first edge 125a and connected to the second edge 125b.

Overall, the end 125 of the conductor element according to the present subject matter forms an engaging and retaining means for a flat-lamina spring 130. The flat-lamina spring 130 has a head 131 and two flat-pin legs 132. The head 131 includes an opening 131a for coupling with the pin 127 of the engaging end of the conductor element. The two flat-pin legs 132 are separated by an interspace 132a. The two legs can have a respective free end forming a tongue 132b inclined outwards at a suitable angle, for facilitating engagement with the rail B and for allowing operation thereof for disengagement from said rail.

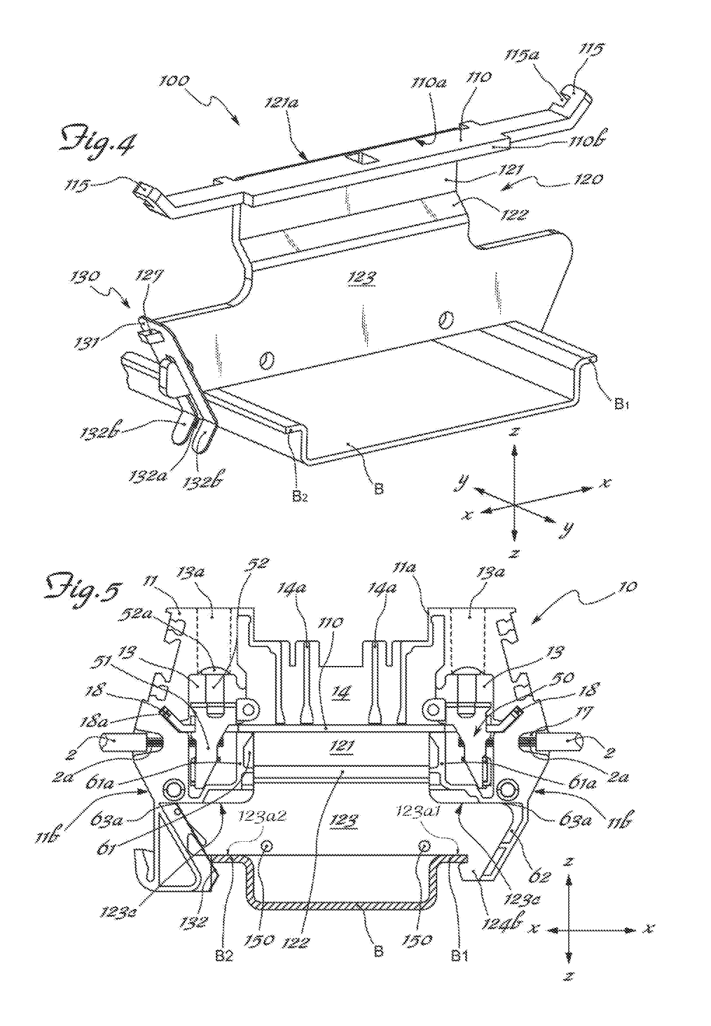

As shown in FIG. 3, mounting of the flat-lamina spring 130 on the engaging end 125 of the grounding conductor element causes relative coupling of the pin 127 with the opening 131a in the head 131 of the flat-lamina spring and resting of the head 131 on the first inclined edge 125a of the engaging end 125; as well as resting of the bottom edge of the head 131, coinciding with the interspace top edge, on the edge 126b of the tooth 126 of the engaging end 125. In this way the resilient spring 130 is arranged with the same inclination determined by the angle α of the first edge 125a so as to cause the free ends of the legs 132 to make contact with and push from the outwards inwards on the folded flange B2 of the rail B opposite to the flange B1 engaging with the tooth 124b of the conductor body 120.

Pin 127 may be riveted so as to ensure the fixing and stability of the coupling. In order to perform engagement with the DIN rail it is sufficient to exert a pressure on the spring so as to produce a resilient deformation of the legs which, reacting against the contact surface formed by the third edge 125c, are deformed outwards so as to allow engagement, facilitated by the inclination of the free ends of the flat-pins. The shaped body 120, once the spring engages with the engaging end 125 of the body, arranges with three engaging points respectively corresponding to the point of engagement of the tooth 124b with the rail B and the contact points of the legs 132 pressing on the said rail. This produces a reaction, which generates a contact force both on the tooth 126 of the contact end 125 and on the tooth 124a of the opposite end 124, as well as between the sections 123a1, 123a2 of the flat resting edge 123a and the top surfaces of the flanges B1,B2 of the rail B, and also between the flat-lamina spring 130 and the respective folded edge of the said rail B.

The three engaging points also ensure both static planarity, once engagement has been performed, and dynamic planarity, during deformation of the legs 132 when performing engagement or disengagement, ensuring correct resting of the end sections of the resting edge 123a on the respective flanges of the rail B, with consequent use of the entire cross-section of the third vertical body section for electrical conduction, of a high conductive contact surface area on the rail B for discharging to earth, as well as stable and easy positioning of the grounding body 120 on the said rail B.

Applying pressure on the flat-pin elements in the opposite direction, outwards, produces an opposite deformation of the legs of the spring, which allows easy disengagement of the grounding element from the rail.

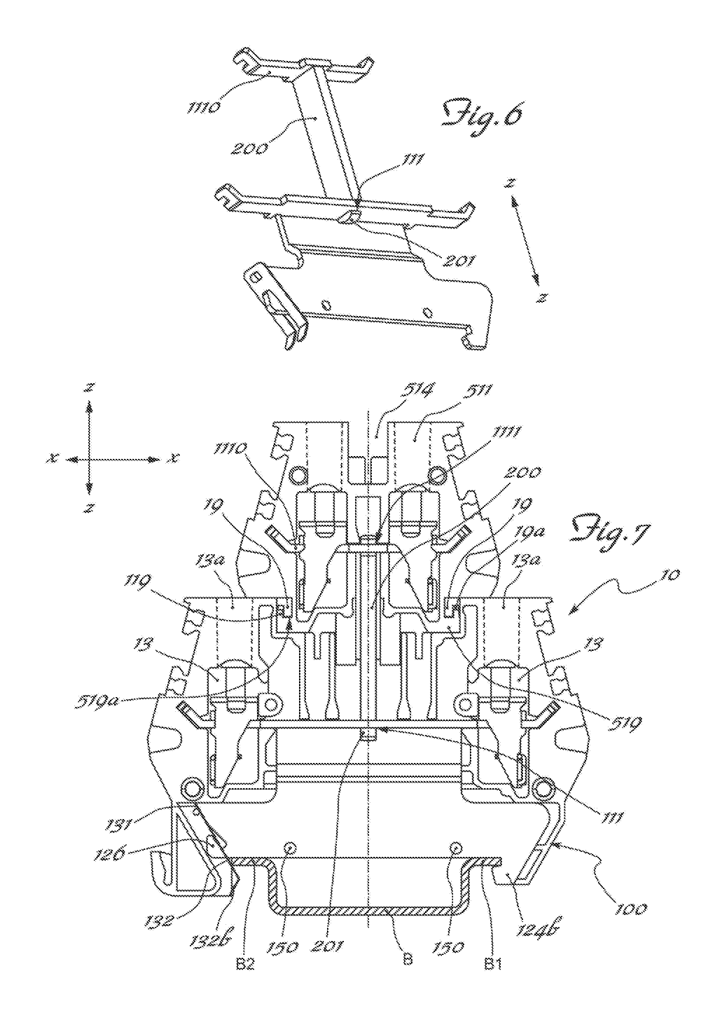

According to a preferred embodiment of the present subject matter, the longitudinal lamina 110 has a central through-opening 111 in the vertical direction Z-Z. The opposite free ends of the lamina 110 can form a tip 115 inclined upwards (FIG. 1) and designed to engage (FIG. 5) with a corresponding internal seat 18 provided on each flank 11b of the frame 11 of a switchboard terminal block, so as to stably fasten the conductor lamina 110 to the insulating body 10.

Preferably, each tip 115 has an incision 115a designed to engage with a corresponding relief 18a in the seat 18 in order to axially retain the lamina when it undergoes an axial deformation owing to the thrust exerted in the vertical direction by the screw of the means for retaining the wire 2.

FIG. 6 shows a second embodiment of the grounding conductor element according to the present subject matter, which envisages a connection with a second longitudinal lamina 1110 arranged on a different level or tier in the vertical direction Z-Z. This embodiment envisages a column 200, preferably with a polygonal cross-section, having ends formed as a tooth 201 suitable for insertion inside the respective openings 111 and 1111 of the respective lamina of the first and second tiers. It also envisages that the teeth 201 can have a length such as to protrude from the respective opening 111,1111 so that they may be stably riveted in order to provide a stable connection with the two laminate 110,1110.

FIGS. 5 and 7 show two switchboard terminal blocks, which have the appropriate seats for housing the corresponding grounding element, of the single tier and double tier type, inserted in the terminal block. The grounding element can have two centering elements 150, in the example two through-holes formed in the third section 123 and designed for coupling with corresponding pins formed in the insulating body 10 of the terminal block.

The present subject matter also relates to a switchboard terminal block suitable for grounding the grounding conductors connected to it and provided with a grounding conductor element according to the present subject matter and described above.

In detail, the grounding terminal block includes an insulating body 10, which forms the container of the grounding conductor element and of means 50 for retaining the free end 2a of electric wires 2. For the sake of convenience of description and with reference to the directional layout shown by way of example, a bottom part corresponding to the part for engagement with a DIN rail B fixed to the electric switchboard, not shown, and a top part visible to the user, opposite to the bottom part, will also be assumed. During use, the top part will correspond to the front visible side of the terminal block mounted on the DIN rail.

In greater detail, insulating body 10 has a frame 11 substantially in the form of a closed ring and formed so as to define at least one front end side 11a and at least two respective flanks 11b for inserting wires 2 arranged opposite to each other in the longitudinal direction X-X.

The body 10 has, formed inside it, at least one pair of seats 13 and a bottom seat 60. The one pair of seats 13 is for housing the means 50 for retaining/releasing the wires. The bottom seat 60 is for housing the conductor body 120. Seat 60 is open at the bottom on the side for engagement with the rail B and is formed with a shape substantially matching that of the conductor body 120.

In greater detail a preferred seat 60 has a first top seat 61 and a second bottom seat 62. The first top seat 61 has a smaller dimension in the longitudinal direction X-X corresponding to the length of the top sections 121 and 122 of the body 120 and is bounded by vertical partitions 61a having a height in the vertical direction Z-Z substantially corresponding to the height of the said sections 121;122. The second bottom seat 62 is for housing the third body section 123, with top inner edges, which have at least one section 63a extending in the longitudinal direction X-X parallel to the top longitudinal edges 123c of the third section 123 of the body 120, so as to form reaction planes in the vertical direction Z-Z of the frame along the conductor body section 123 (and vice versa) during engagement/disengagement. The convex inner surfaces 64 at the longitudinally outer ends of the edges 63 are formed to correspond to the outer edges of the body 120. In particular, a first surface is parallel to the first edge 125a and extends in the vertical direction as far as the free ends of the legs of the flat-lamina spring, while the opposite inner surface complements the outer surface of the end 124 with tooth 124b.

The top wall 11a of the frame 11 may also be provided with (see FIG. 5) holes 13a and a first aperture 14. The holes 13a can have a vertical axis Z-Z which are respectively aligned with said second seats 13 and can be designed to connect the latter with the exterior. The first aperture 14 can be centred along a vertical central axis Z-Z and bounded in the longitudinal direction X-X by respective first partitions 14a interrupted in the vertical direction Z-Z by a section having a height such as to allow insertion of the conductor lamina 110 for restoring the electrical continuity between the opposite wires 2. Divisions 14a are spaced from each other in the longitudinal direction X-X by an amount such as to define a dimension of the aperture suitable for housing circuit elements, for allowing connection, where necessary, of the body 120 to the auxiliary pole.

Each lateral flank 11b of the frame 11 is provided with a respective opening 17 communicating with a respective seat of the seats for housing the retaining/releasing means 50 for introducing the wire 2 in the longitudinal direction X-X. In the example shown in FIG. 5, the means 50 for retaining the electric wire 2 are of the clamp type 51 with actuating screw 52. The head 52a of said screw 52 is accessible from the outside by means of the said hole 13a with vertical axis Z-Z through which it is possible to insert the operating tool for rotating the screw, the tip of which, reacting against the surface of the lamina 110, recalls the clamp 51, which grips the end of the wire 2 between clamp and lamina.

Although not shown, it is envisaged that the means for retaining the wire 2 may be of the spring type.

As shown, the laterally open terminal block 10 is assembled by: inserting inside it (in the vertical direction Y-Y) the grounding element according to the present subject matter so that the opposite inclined tips 115 of the lamina 110 and the body 120 enter into the respective seats 18,60 of the insulating body 10 of the terminal block; and the means 50 for retaining the wire 2 inside the respective seat 13; closing the terminal block with a cover, not shown; inserting the wires 2 inside the respective insertion seats 17 and operating the actuating screw of the retaining means so as to grip the said wires against the conductor lamina; and inserting any further circuit elements inside the respective seats.

Owing to the particular arrangement of the second engaging end 125 and the spring 130 connected to it, the assembled terminal block may be easily engaged/disengaged with/from the DIN rail merely by means of pushing/pulling in the vertical direction Z-Z.

FIG. 7 shows a second preferred embodiment of the terminal block according to the subject matter, which has a pair of teeth 19 in the form of an “overturned L” formed on the outermost wall of the opposite vertical edges 16c of a front recess 16 formed in the top side 11a of the frame 11 of the terminal block. Teeth 19 form a respective L-shaped inset seat 19a provided in the respective vertical edge 16c of the recess 16.

The teeth 19 with respective seat 19a are designed to receive corresponding projections 519 projecting outwards in the longitudinal direction X-X and formed in the bottom part of the frame 511 of an auxiliary terminal block 500 having lengthwise dimensions in the axial direction X-X smaller than those of the grounding terminal block.

The longitudinal dimension of the auxiliary upper-tier terminal block 500 is such as to leave exposed the hole 13a for access to the screw for actuating the means 50 for gripping the bottom wires 2 against the conducting lamina 111.

The joining together in the transverse direction Y-Y of the two frames 11 and 511 of the terminal blocks produces an assembly with two tiers, i.e. upper tier and lower tier—according to the non-limiting directional layout shown in the figure—suitable for housing a two-tier grounding element such as that shown in FIG. 6.

The upper-tier terminal block 500 has a structure and component parts similar to those of the bottom terminal block and is therefore not described in detail.

It is therefore clear how the grounding conductor element for switchboard terminal blocks according to the present subject matter allows easy, rapid and safe reversible connection with the flanges of a DIN switchboard rail. In addition, the terminal block according to the present subject matter provided with this grounding element may in turn be easily handled by the user in a safe, repeatable and easy manner for engagement/disengagement with/from the DIN rail.

As used above and assuming solely for easier description and without a limiting meaning a set of three reference axes, respectively extending in a longitudinal direction X-X, corresponding to a lengthwise dimension of the grounding conductor element, transverse direction Y-Y, corresponding to a width or thickness of the grounding conductor element, and vertical direction Z-Z, corresponding to a heightwise dimension of the grounding conductor element according to the present subject matter.

1. A conductor element for switchboard terminal blocks comprising a conductor body the conductor element comprising:
a conductor lamina extending in a longitudinal direction and designed to electrically connect together two wires in the longitudinal direction;
a substantially vertical shaped body extending in the longitudinal direction, and having a bottom body section, the bottom body section including:
a bottom free edge extending in the longitudinal direction, the bottom free edge including a first edge section for resting in the vertical direction on a first flange of the two folded flanges of a DIN-standard rail;
a first end proximal to said first edge section and including a bottom edge having a first tooth for engaging with the first flange of the DIN-standard rail;
a second end opposite to the first end and formed engage and retain a spring; wherein the bottom free edge has a second edge section proximal to said second end and aligned in the vertical direction with the first edge section, for conductively resting in the vertical direction on a second flange of the two folded flanges of the rail;
a flat-lamina spring including a head and two flat-pin legs which are separated by an interspace and the respective free ends of the two flat-pin legs are resiliently deformable so as to be arranged, during use, to contact and push from the outside, for engaging with the other folded flange of the rail B, and so as are designed to allow operation thereof for disengagement from said rail;
wherein said second end is adapted to engage and retain the flat-lamina spring.

2. The conductor element according to claim 1, wherein the free ends of the legs of the flat-lamina spring form a respective tongue inclined outwards at a suitable angle and facilitating engagement or disengagement of the conductor element with or from the rail.

3. The conductor element according to claim 1, wherein said second end for coupling with the flat-lamina spring has a first edge inclined at a suitable angle with respect to a top, horizontal, longitudinal edge parallel to the bottom free edge resting on the rail.

4. The conductor element according to claim 1, wherein the bottom free edge for resting on the rail is a bottom free edge of the bottom body section which is arranged in a vertical plane within the width of the conductor lamina in the transverse direction.

5. The conductor element according to claim 4, wherein said substantially vertical shaped body comprises:
a first substantially vertical section with a top edge connected in the transverse direction to a longitudinal edge of the conductor lamina with which it forms one piece;
a second section inclined with respect to the first substantially vertical section from a top downwards and from the longitudinal edge towards a free edge of the conductor lamina at a suitable angle Ω; wherein the bottom body section has a top edge connected to the second section and the free bottom edge for resting on the rail.

6. A conductor element according to claim 3, wherein the first edge has a pin extending outwards in the longitudinal direction for engagement with a respective seat in the head of the flat-lamina spring.

7. The conductor element according to claim 3, wherein said second end for coupling with the flat-lamina spring has a second edge inclined inwards at a suitable obtuse angle with respect to the first edge and connected to a second tooth for engagement with the head of the flat-lamina spring.

8. The conductor element according to claim 7, wherein said second tooth has an inner edge connected to the second edge and parallel to the first edge and an outer edge substantially parallel to the vertical direction.

9. The conductor element according to claim 1, further comprising a second longitudinal conductor lamina arranged on a different tier in the vertical direction with respect to the conductor lamina.

10. The conductor element according to claim 9, further comprising a conducting column extending in the vertical direction for electrically connecting together the conductor lamina and the second longitudinal conductor lamina.

11. The conductor element according to claim 10, wherein the opposite ends of the conducting column form a third tooth for insertion inside respective openings (111;1111) in the respective conductor lamina and the second longitudinal conductor lamina.

12. The conductor element according to claim 11, wherein the first tooth, the second tooth, and the third tooth each have a length such as to protrude from respective openings and are riveted for stable joining together with the respective conductor lamina and the second longitudinal conductor lamina.

13. A switchboard terminal block for grounding ground conductors connected to it, the switchboard terminal block comprising a grounding conductor element, the grounding conductor element including a conductor body comprising:
a conductor lamina extending in a longitudinal direction and designed to electrically connect together two wires in the longitudinal direction;
a substantially vertical shaped body extending in the longitudinal direction, and having a bottom body section, the bottom body section including:
a bottom free edge extending in the longitudinal direction, the bottom free edge including a first edge section for resting in the vertical direction on a first flange of the two folded flanges of a DIN-standard rail;
a first end proximal to said first edge section and including a bottom edge having a first tooth for engaging with the first flange of the DIN-standard rail;
a second end opposite to the first end and formed to engage and retain a spring, wherein the bottom free edge has a second edge section proximal to the second end and aligned in the vertical direction with the first edge section, for conductively resting in the vertical direction on a second flange of the two folded flanges of the rail; and
a flat-lamina spring including a head and two flat-pin legs separated by an interspace and the respective free ends of the two flat-pin legs are resiliently deformable so as to be arranged, during use, to contact and push from the outside, for engaging with the other folded flange of the rail B, and to allow operation thereof for disengagement from said rail;
wherein said second end is adapted to engage and retain the flat-lamina spring.

14. The switchboard terminal block according to claim 13, further comprising an insulating body formed by a substantially closed-ring frame and configured to define at least one front end side and at least two respective flanks for inserting wires, opposite to each other in the longitudinal direction, said insulating body forming the container of the grounding conductor element and of a means for retaining the end of the two wires.

15. The switchboard terminal block according to claim 13, further comprising at least one pair of seats for housing the means for retaining the end of the two wires and a bottom seat which is formed with a shape substantially complementing the substantially vertical shaped body so as to contain it and is open at the bottom on the side for engagement with the rail.

16. The switchboard terminal block according to claim 15 said bottom seat comprising:
a first top seat having a smaller dimension in the longitudinal direction corresponding to the length of the first substantially vertical section and the second section of the substantially vertical shaped body and bounded by vertical partitions having a height in the direction substantially corresponding to the height of the first substantially vertical section and the second section;
a second bottom seat for housing a third body section, with top inner edges which have at least one section extending in the longitudinal direction parallel to the top longitudinal edges of the third body section of the body, so as to form reaction planes in the vertical direction of the frame on the third body section during engagement or disengagement.
